(19) United States
(12) Patent Application Publication
(10) Pub. No.: US 2004/0249985 A1
(43) Pub. Date: Dec. 9, 2004

(54) Host network interface device and drive network interface device

(76) Inventors: Toshiaki Mori, Minoo-shi (JP); Susumu Ibaraki, Yokohama-shi (JP); Toshikazu Hattori, Yokohama-shi (JP); Akihiro Yamamoto, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/492,687

(22) PCT Filed: Oct. 7, 2002
(86) PCT No.: PCT/JP02/10402

(30) Foreign Application Priority Data
Oct. 18, 2001 (JP) 2002-320382

(51) Int. Cl. G06F 15/16

(52) U.S. Cl. 709/250

(57) ABSTRACT

An IDE interface unit (11) reads out a value of an ATA register in a DVD drive (1) repeatedly and sends the value to a host network interface device (4a). The host network interface device (4a) retains the register value in a shadow register (23). An IDE interface unit (21) sends a value of the shadow register (23) to a DVD decoder (2) (host) upon receiving a reading out signal of a register value in the ATA register (31). Thus, since a register reading out controlling signal is not sent via networks, there is no transmission delay that effects to the network.

### TECHNICAL FIELD

The present invention relates to a network interface device that establishes communication between a host and a device with a direct connection basis via a network, and more particularly to a technique for reducing a transmission delay when sending and receiving information such as a command, a control signal and data via networks.

### BACKGROUND ART

As is well known, a host for a computer is directly connected to a drive such as a hard disk drive, a DVD drive or a CD drive with a relatively short cable. Information such as a command, a control signal or data is sent/received based on a communication standard which is common to the host and the drive. FIG. 1A to 1D are examples of the communication specification, that is, an outline of a communication flow of a command and a control signal established between the host and the drive connected with an ATA/ATAPI STD interface.

FIG. 1A is a block diagram that shows a communication procedure for reading out status information stored in an ATA register in a drive. When a host sends a signal for reading out the status, a drive outputs the status information as a data signal.

FIG. 1B is a block diagram that shows a communication procedure when a host sends an ATAPI command packet to a drive. First of all, the host sends “ATAPI Packet” command to the drive, secondly, sends a signal for reading out the status to the drive. Thirdly, after the drive outputs the status, the host sends the ATAPI command packet to the drive.

FIG. 1C is a block diagram that shows a communication procedure when a host reads out data from a drive via a DMA transfer. First of all, when the host sends a “READ DMA” command to the drive, the drive asserts the DMARQ. Secondly, when the host asserts the DMACK, the drive starts data transfer.

FIG. 1D is a block diagram that shows a communication procedure when a host writes data to a drive via a DMA transfer. First of all, when the host sends a “WRITE DMA” command to the drive, the drive asserts the DMARQ, and then the host asserts the DMACK. Secondly, when the drive asserts the DDMARDY, the host starts data transferring.

There is a demand for the host and the drive to divert to a car navigation system, etc. For meeting the demand, since a GPS has to be connected, it is necessary for the host and the drive to have a network connected with a domestic network or an in-vehicle network so as for the host and the drive to be able to transmit a command, etc, via those networks.

One of the method for transmitting the command, etc, is to send the command and the control signal, which are sent/received between the host and drive (as shown in FIG. 1), in the packet form via network, as shown in FIG. 1.

There is a file system (refer to Japanese Patent laid-open application No.11-7404) that includes a network connecting type SCSI device applied the above method to a transmission that transmits commands which conforms to the SCSI standards via a network.

However, when transmitting all the commands or control signals via a network, and when there is a transmission delay in the network, a problem, of lowering the processing speed in the host due to the response waiting time, etc, will arise.

More specifically, in the case of FIG. 1A, the time for the transferring the status of the ATA register to the host after the status read is sent from the host is to be longer. And, the case of FIG. 1B is also a time consuming operation until the command packet is to be sent from the host, that is, it takes lots of time to transmit the packet command, the status read, or the status. And, as well the case of FIG. 1C, it is a time consuming operation for transmitting the DMARQ and the DMACK. In the case of FIG. 1D, transmitting the DMARQ, the DMACK or the DDMARDY also takes a lot of time.

Above-mentioned time delay will consequently make lower a stability of a real time controlling for decoding a DVD video data. This problem will as well occur when using a host and a drive which are adjusted to the SCSI-standard.

The object of the present invention is, in the light of the above-mentioned problem, to provide a network interface device which reduces an influence of the network transmission delay to the host processing.

### DISCLOSURE OF INVENTION

In order to achieve the above object, the drive network interface device according to the present invention, connected between a drive that is able to do at least any one of reading and writing, and a network, comprises a network connecting unit that establishes a communication with the network and a drive interface, that is connected to the drive for communication, that reads out a status of the drive periodically as a substitute for a partner's device and to send the status to a partner's device via a network connecting unit and the network. And the host network interface device according to the present invention, connected between a host and a network, comprises a network connecting unit that receives a status of the drive periodically via the network, a shadow register that memorizes the status and a host interface that updates and memorizes the status received by the network connecting unit in the shadow register and send the status in response to a status reading out request sent by the host.

According to the above components, a reading out controlling signal is not sent to the drive via the network when the host read out the register of the drive. Thus, the processing speed in the host is increased since the host will not suffer any influences of the transmission delay in the network.

The host network interface device according to the present invention, connected between a host and a network, comprises a network connecting unit that establishes a communication with the network, a substitution unit, which is connected to the host for communication, that executes a series of information sending and receiving processing with the host as a substitute for a partner's device, upon receiving the information for the partner's device from the host, and sends only the entity information to the partner's device via the network connecting unit and the network. And the drive network interface device according to the present invention, connected between a drive that is able to do at least any one of reading and writing, and a network, comprises a network connecting unit that establishes a communication with the network, a substitution unit, which is connected to the drive for communication, that executes a series of information sending and receiving processing with a disk as a substitute for a partner's device and sends only the entity information to the partner's device via the network connecting unit and the network upon receiving information from the partner's device.

The host network interface device comprises a host interface, a network connecting unit and a protocol controlling unit. The host interface converts the communication between the host and the protocol controlling unit and relay the communication. The network connecting unit converts the communication between the network and the protocol controlling unit and relay the communication. The protocol controlling unit sends a command packet via the network upon receiving a command which is a notice for sending a command packet from the host. And the drive network interface device according to the present invention comprises a drive interface, a network connecting unit and a protocol controlling unit. The drive interface converts the communication between the host and the protocol controlling unit and relay the communication. The network connecting unit converts the communication between the network and the protocol controlling unit and relay the communication. The protocol controlling unit executes a series of signal sending and receiving processing upon receiving a command which is a notice for sending a command packet to the drive, and then sends the command packet to the drive.

According to the above components, when the host sends a ATAPI command packet to the drive, prior to the sending, an ATAPI packet command and a status reading out signal, which are sent from the host, are not sent to the drive via the network, the host will not suffer any influences of the transmission delay in the network, thus the processing speed in the host increases.

The host network interface device according to the present invention comprises a host interface and a network connecting unit. The network connecting unit converts the communication between the network and the host interface and relay the communication. The host interface executes a series of information sending and receiving processing with the host after sending a DMA reading out command via the network connecting unit and the network, upon receiving the command from the host, and then sends a data received from the network to the host. The drive network interface device according to the present invention comprises a drive interface and the network connecting unit. The network connecting unit converts the communication between the network and the drive interface and relay the communication. The drive interface sends a DMA reading out command to the drive when the network connecting unit receives the DMA reading out command, then executes a series of signal sending and receiving processing until a period of starting DMA transfer with the drive, and sends the data received from the drive to the network.

According to the above components, when the host reads out data from the drive or when the host writes data to the drive, the DMA controlling signal is not transmitted between the host and the drive via the network, thus the host and the drive do not suffer the influence of the transmission delay in the network.

The host network interface device according to the present invention comprises a host interface and a network connecting unit. The network connecting unit converts the communication between the network and the host interface and relay the communication. The host interface executes a series of information sending and receiving processing with the host after sending a DMA writing command via the network connecting unit and the network, upon receiving the command from the host, and then sends a data received from the network to the host. The drive network interface device comprises a drive interface and a network connecting unit. The network connecting unit converts the communication between the network and the drive interface and relay the communication. The drive interface sends a DMA writing command to the drive when the network connecting unit receives the DMA writing command, then executes a series of signal sending and receiving processing until a period of starting data transfer with the drive, and sends the data that the network connecting unit received to the drive.

According to the above components, when the host writes data to the drive, the DMA controlling signal is not transmitted between the drive and the host via the network, the host will not suffer any influences of the transmission delay in the network, thus the processing speed increases in the host.

In other words, according to the present invention, the status reading out signal, the ATAPI packet command, or the DMA controlling signal are not sent via the network in the communication between the host and the drive. Thus, the processing speed increases in the host because of not having an influence of the transmission delay in the network. As a result, a stability for an operation is promoted at the time of a real time controlling of the video sound for decoding a DVD video data.

Above such effect works best when the transmission is relatively slow or the transmission band limit is narrow. So the present invention's practicality is extremely high.

The present invention is realized as a combination device of the drive network interface device and its corresponding device, realized as a combination device of a host network interface device and its corresponding device, realized as a communication system comprising a drive, a drive network interface device, a host network interface device and a host or realized as an information transmitting method that the units, in the drive network interface device and the host network interface device, to work as steps.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings:

FIG. 1A is a conventional communication procedure of ATA/ATAPI for reading out status information stored in an ATA register in a drive.

FIG. 1B is a conventional communication procedure when a host sends an ATAPI command packet to a drive.

FIG. 1C is a conventional communication procedure when a host reads out data from a drive via a DMA transfer.

FIG. 1D is a conventional communication procedure when a host writes data to a drive via a DMA transfer.

FIG. 2 is a block diagram that shows an overall configuration of the disk system 100a according to the first embodiment.

FIG. 3 is a sequence diagram that shows a communication flow between devices shown in FIG. 2.

FIG. 4 is a block diagram that shows a constructional example of the drive network interface device according to the second embodiment.

FIG. 5 is a block diagram that shows a constructional example of the host network interface device according to the second embodiment.

FIG. 6 is a flow chart that shows an operation of the protocol controlling unit 24 of FIG. 4.

FIG. 7 is a flow chart that shows an operation of the protocol controlling unit 14 of FIG. 5.

FIG. 8 is a sequence diagram that shows a communication flow of the disk system 100b according to the second embodiment.

FIG. 9 is a flow chart that shows an operation of the host network interface device 4b according to the third embodiment.

FIG. 10 is a flow chart that shows an operation of the drive network interface device 3b according to the third embodiment.

FIG. 11 is a sequence diagram that shows a communication flow between devices of the disk system 100b according to the third embodiment.

FIG. 12 is a flow chart that shows an operation of the host network interface device 4b according to the third embodiment.

FIG. 13 is a flow chart that shows an operation of the drive network interface device 3b according to the third embodiment.

FIG. 14 is a sequence diagram that shows a communication flow between devices of the disk system 100b according to the third embodiment.

FIG. 15 is a diagram that shows a car inside applied the disk system 100a (100b) to a car navigation system.

FIG. 16 is a diagram that shows a home inside applied the disk system to a home network.

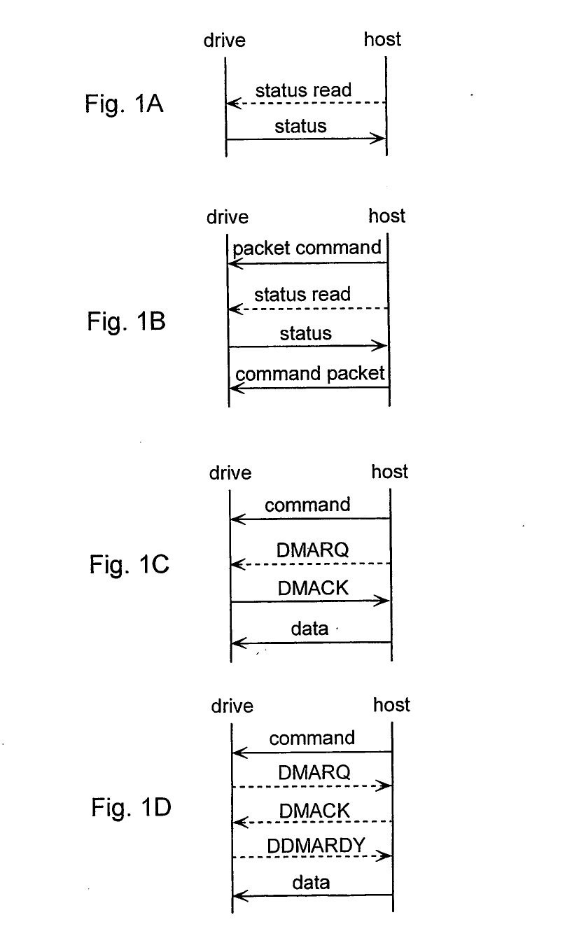

### BEST MODE FOR CARRYING OUT THE INVENTION

The following is an explanation of the disk system according to the embodiments of the present invention with reference to figures.

(The First Embodiment)

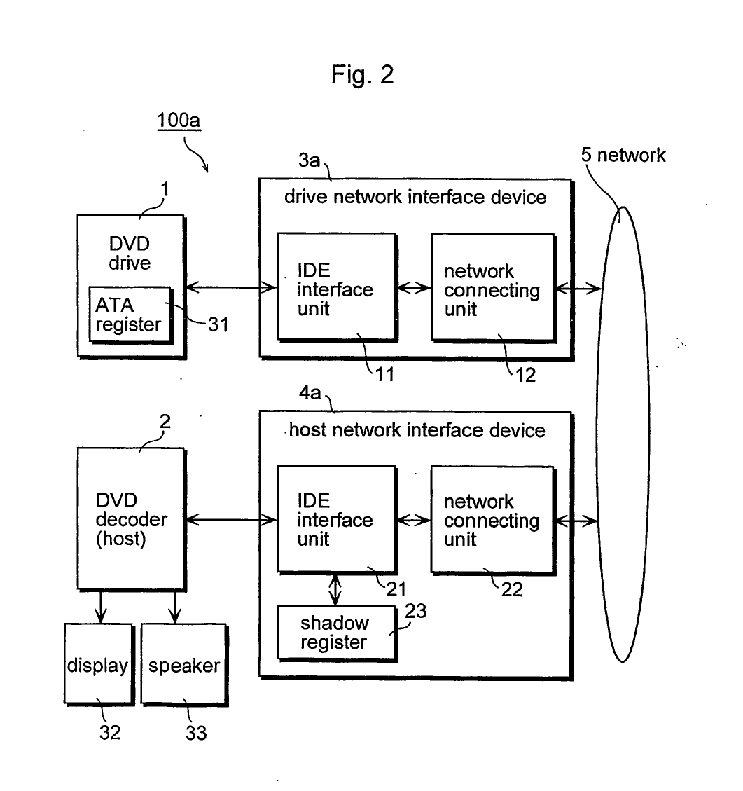

FIG. 2 is a functional block diagram that shows an overall configuration of the disk system 100a according to the first embodiment.

The disk system 100a according to the first embodiment of the present invention is a communication system that is installed in a movable body such as a car and distributes contents, such as movies according to user's preference, in a stream form. The system includes a DVD drive 1, a DVD decoder 2 (hereinafter also referred to as a “host”), a network 5, a drive network interface device 3a that is connected between the DVD drive 1 and the network 5 establish a communication, a host network interface device 4a that is connected between the host 2 and the network 5 to establish a communication, a display 32 and a speaker which are connected to the host 2.

The DVD drive 1 is a disk device that reads out an video/sound data recorded on the disk (DVD) inserted into a tray or writes a data, and has an IDE interface as a communication interface (an external interface) for connecting to a external device and an ATA register 31 in inside.

The host 2 is a computer device that decodes a sector data of a DVD and outputs an video data to the display 32 and a sound data to the speaker 33, and is having an IDE interface (not shown in FIG.) as a communication interface (external interface) for connecting to an external device.

The network 5 is an optical transmission channel that is installed inside cars based on a transmission system, for example, the MOST (Media Oriented Systems Transport).

The drive network interface device 3a is a device that sends an information such as a register value (status) of the ATA register 31 sent from the DVD drive 1 or a sector data of the disk, to the network 5, or sends an information such as a command, a control signal or a data received from the network 5, to the DVD drive 1, and comprises an IDE interface unit 11 and a network connecting unit 12. The IDE interface unit 11 is connected to the IDE interface in the DVD drive 1 with a cable adjusted to the ATA-standard for communicating with the DVD drive 1 and the network connecting unit 12. The network connecting unit 12, connected to the network 5 with an optical connector, etc, communicates with the IDE interface unit 11 directly and the host network interface device 4a via the network 5. More specifically, the IDE interface unit 11 converts the signal of the IDE interface and the data on the network 5 mutually. The network connecting unit 12 sends a signal received from the IDE interface unit 11 to the network 5. The signal received from the network 5 is sent to the IDE interface unit 11. In addition, a communication between the network connecting unit 12 and the host network interface device 4a is established using packets adjusted to the transmission system of MOST.

The host network interface device 4a is a device that sends information sent from the host 2 to the network 5 or sends information received from the network 5 to the host 2 and comprises an IDE interface unit 21, a network connecting unit 22 and a shadow register 23. The shadow register 23 retains a data which is the same contents as that of the ATA register 31. The IDE interface unit 21 executes the same operation with the IDE interface unit 11 but there is a different operation, that is, the IDE interface unit 21 executes a reading/writing processing of the register value to the shadow register. The network connecting unit 22 executes the same operation with the network connecting 12. More specifically, the IDE interface unit 21 is connected to the IDE interface in the host 2 with a cable adjusted to the ATA-standard and communicates with the host 2 and the network connecting unit 22. The network connecting unit 22, connected to the network 5 with an optical connector or etc, communicates with the IDE interface unit 21 directly and the drive network interface device 3a via the network 5.

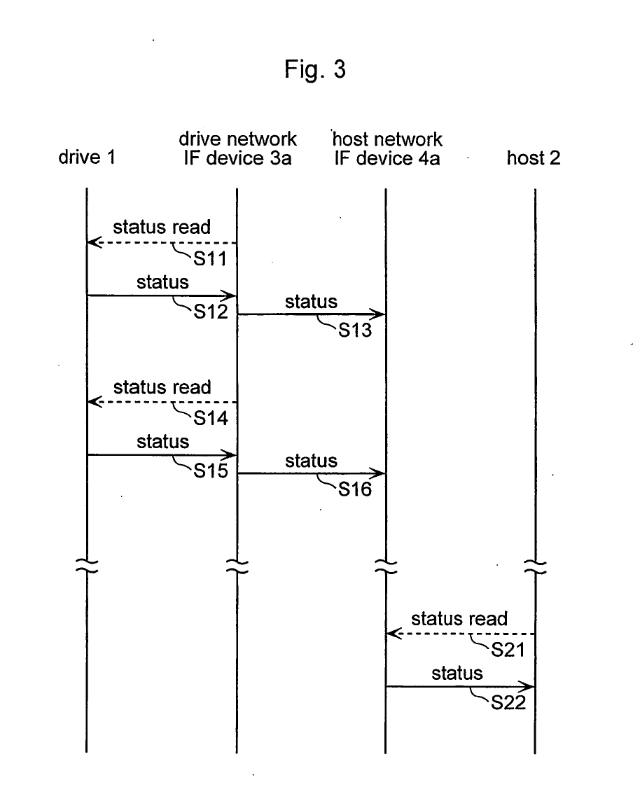

Following is an explanation for a major part of the components of the disk system 100a shown in FIG. 2. The explanation is made based on a sequence diagram shown in FIG. 3.

First of all, an operation of the drive network interface device 3a is described.

The IDE interface unit 11 in the drive network interface device 3a reads out a value of the ATA register 31 in the DVD drive 1 and sends it to the network connecting unit 12. More specifically, the IDE interface unit 11 sends information such as a “status read” to the DVD drive 1 (S11), reads out a value of the status register in the ATA register 31 (S12) and sends it to the network connecting unit 12. The network connecting unit 12 puts an address of the host network interface device 4a to the received register value data and sends it to the host network interface device 4a via the network 5 (S13). The drive network interface device 3a repeats the above operation periodically (S14 to S 16 . . . ).

Following is an explanation for an operation of the host network interface device 4a. Every time the network connecting unit 22 in the host network interface device 4a receives a register value data sent from the drive network interface device 3a (S13, S16, . . . ), every time the IDE interface unit 21 receives a register value data from the network connecting unit 22, the network connecting unit 22 sends the received data to the IDE interface unit 21. The IDE interface unit 21 updates/stores the each received data to the shadow register 23 as a latest register value data. When the IDE interface unit 21 receives a status read which is a signal for reading out a register value of the ATA register 31 from the DVD decoder 2 (S21), the IDE interface unit 21 reads out the resister value (status) stored in the shadow register 23 without transferring the status read to the network connecting unit 22 and sends the register value to the DVD decoder 2 (host) (S22).

As described above, according to the disk system 100a of the first embodiment, when reading out the register (ATA register 31) of the DVD drive 1 from the host 2, the register value of the ATA register is updated and stored in the shadow register 23 periodically by the drive network interface device 3a and the host network interface device 4a so as not to send a reading out control signal (status read) sent from the host 2, to the network. Accordingly, the DVD decoder 2 is able to obtain the status of the DVD drive 1 without suffering from any influences of the transmission delay occurred in the network. As a result, the processing speed increases in the host 2. Thus, a stability for an operation is promoted at the time of a real time controlling of the video sound for decoding a DVD video data.

(The Second Embodiment)

Following is an explanation of a disk system of the second embodiment according to the present invention.

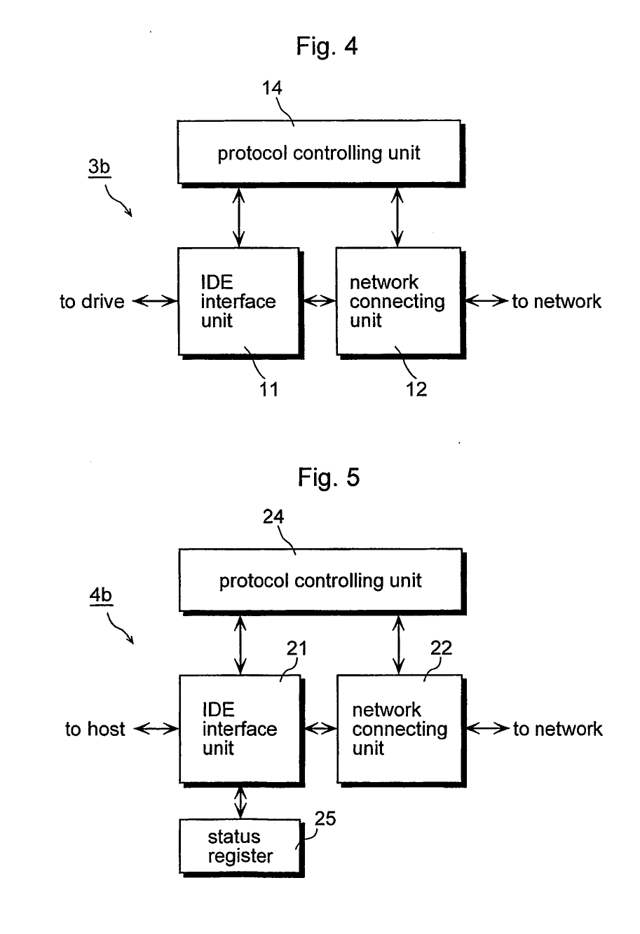

The disk system 100b according to the second embodiment is as the same components with the disk system 100a shown in FIG. 2, however the system is comprised of a drive network interface device 3B as shown in FIG. 4 in place of the drive network interface device 3A and a host network interface device 4B as shown in FIG. 4 in place of the host network interface device.

The drive network interface device 3B, as shown in FIG. 4, is comprised of a protocol controlling unit 14, connected to the IDE interface unit 11 and the network connecting unit 12 to establish a communication, besides the IDE interface unit 11 and the network connecting unit 12.

The protocol controlling unit 14 receives a command sent from the host network interface device 4B, from the network connecting unit 12. The protocol controlling unit 14 also receives a status sent from the DVD drive 1, from the IDE interface unit 11. The protocol controlling unit 14 sends a command or a response for the command based on the received command or status to the IDE interface unit 21 or to the network connecting unit 22. More specifically, when the protocol controlling unit 14 receives entity information, a command packet via the network connecting unit 12, the protocol controlling unit 14 makes a necessary communication with the DVD drive 1 in place of the host 2 via the IDE interface unit 11 until the command packet will to be sent.

Also, the host network interface device 4B is comprised of a protocol controlling unit 24, connected to the IDE interface unit 21 and the network connecting unit 22 to establish a communication, besides the IDE interface unit 21 and the network connecting unit 22 and a status register 25 in place of the shadow register 23.

The status register 25 retains a status of the IDE interface unit 21 with the same format with the ATA register 31.

The protocol controlling unit 24 receives a command sent from the host 2 from the IDE interface unit 21. And the protocol controlling unit 24 sends a command or a response for the command based on the received command to the IDE interface unit 21 or the network connecting unit 22. More specifically, the protocol controlling unit 24 makes a necessary communication until the command packet is to be sent with the host 2 in place of the DVD drive 1 via the IDE interface unit 21 until a period of receiving an entity information (a command packet) via the IDE interface unit 21.

Next, here is an explanation of a disk system 100b according to the second embodiment.

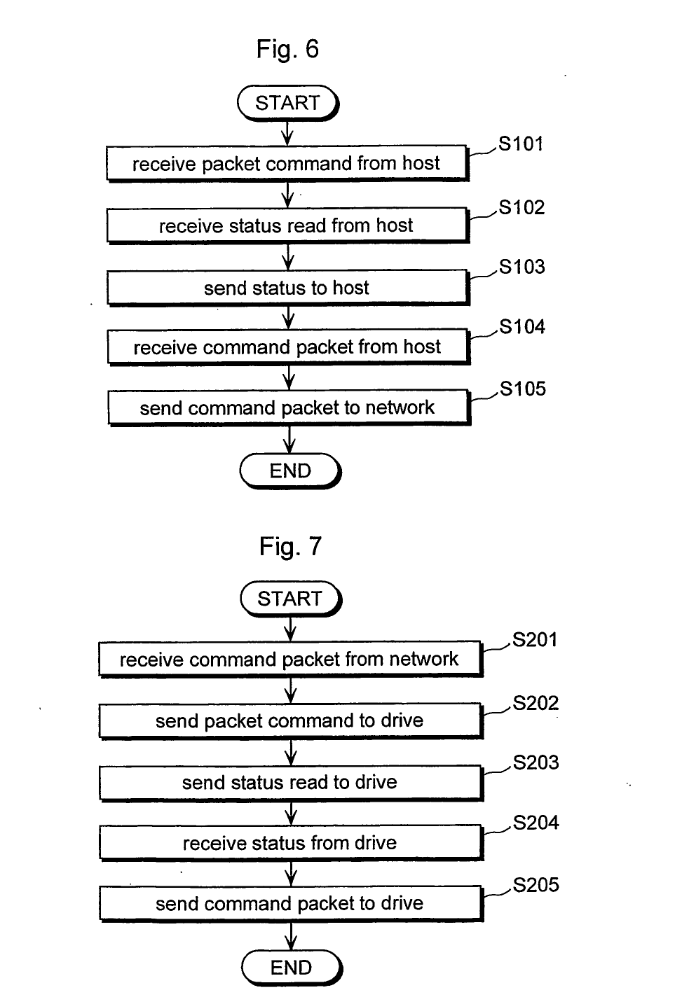

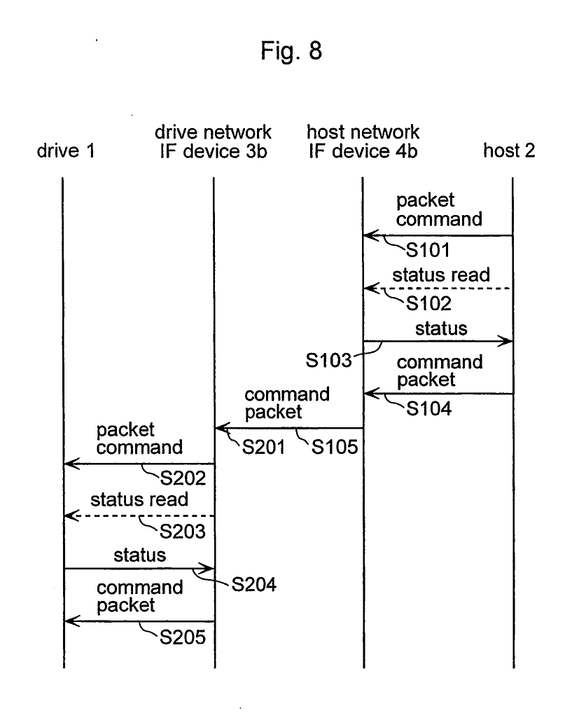

FIG. 6 is a flow chart that shows an operation of the protocol controlling unit 24 in the host network interface device 4B. FIG. 7 is a flow chart that shows an operation of the protocol controlling unit 14 in the drive network interface device 3B. FIG. 8 is a sequence diagram that shows a communication flow between each devices of the disk system 100b.

First of all, following is an explanation of the host network interface device 4B. The protocol controlling unit 24 in the host network interface device 4B receives an ATAPI packet command via the IDE interface unit 21 sent from the host 2 (S101). Then, when the protocol controlling unit 24 receives a signal (status read) for reading out a status in the DVD drive 1 (S102), the protocol controlling unit 24 reads out a register value (status) from the status register 25 and sends it to the host 2 (S103). When the protocol controlling unit 24 receives a command packet from the host 2 which received the status via the IDE interface unit 21 (S104), the command packet is sent to the network connecting unit 22. When the network connecting unit 22 receives the command packet from the protocol controlling unit 24, the network connecting unit 22 puts an address of the drive network interface device 3B to the received command packet and sends the command packet to the drive network interface device 3B (S105).

In other words, only the entity for controlling the DVD drive 1 (the command packet) is sent to the drive network interface device 3B via the network 5. The host network interface device 4B executes a processing of sending/receiving of the entity (the packet command, the status read and the status) in place of the DVD drive 1 so as not to send the packet command and the status read to the network 5.

Accordingly, the host 2 will not be suffered an influence by the transmission delay in the network.

Next, following is an explanation of an operation of the drive network interface device 3B.

FIG. 7 is a flow chart that shows an operation of the protocol controlling unit 14 in the drive network interface device 3B.

When the network connecting unit 12 receives the command packet sent from the host network interface device 4B via the network 5, the network connecting unit 12 sends the received command packet to the protocol controlling unit 14.

When the protocol controlling unit 14 receives the command packet from the network connecting unit 12 (S201), a packet command and a signal (status read) for reading out a status which stored in the ATA register 31 in the DVD drive 1 are generated in response to the received command packet. The protocol controlling unit 14 sends the generated packet command to the drive via the IDE interface unit 11 (S202), then the status read is to be sent (S203). When the status is received from the DVD drive 1 (S204), the protocol controlling unit 14 sends the command packet received in the step S201 to the drive (S205).

In other words, the drive network interface device 3B only receives the entity (the command packet) for controlling the DVD drive 1 via the network 5. The host network interface device 3B executes a processing of sending/receiving of the packet command, the status read and the status, in place of the host 2, after that, sends the command packet to the DVD drive 1 so as not to send the status read to the network 5.

As a result, the DVD drive 1 also, will not be suffered an influence by the transmission delay in the network.

As stated above, according to the disk system 100b of the second embodiment, when the host transmits the ATAPI command packet to the drive, the ATAPI packet command and the status reading out signal, which are sent from the host, are not sent to the drive via the network prior to the transmitting of the ATAPI command. As a result, the processing time of decoding a DVD data or of the host are increased. Especially, a stability for an operation is promoted at the time of a real time controlling of the video sound for decoding a DVD video data.

(The Third Embodiment)

Following is an explanation for a disk system of the third embodiment according to the present invention.

Since this disk system only differs a data reading/writing processing part with the second embodiment, and the component is the same with the disk system 100b, so, the detailed explanation is to be omitted. An explanation is to be made only focusing on an operation of the data reading/writing processing referring to figures.

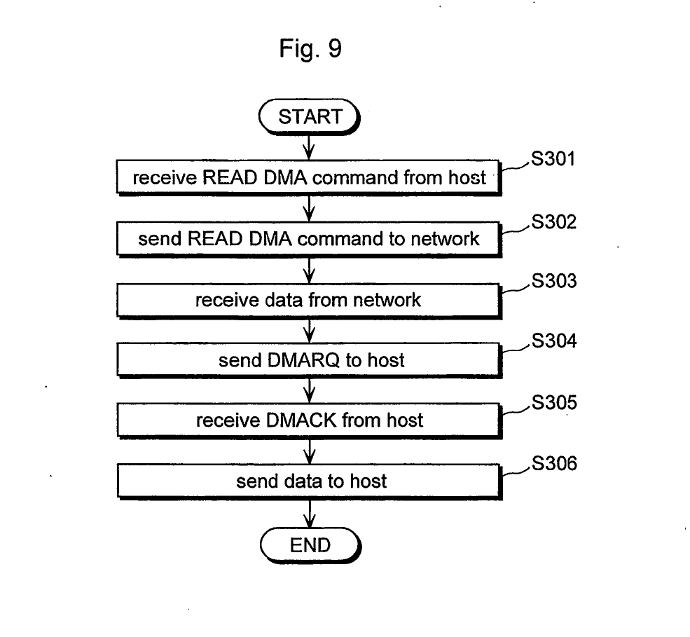

First of all, look at FIG. 9 to see how the network interface device operates when the host 2 reads out data in the drive.

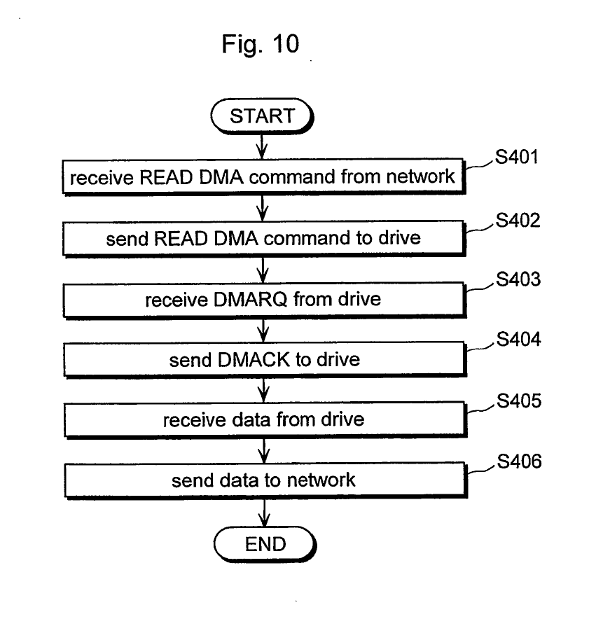

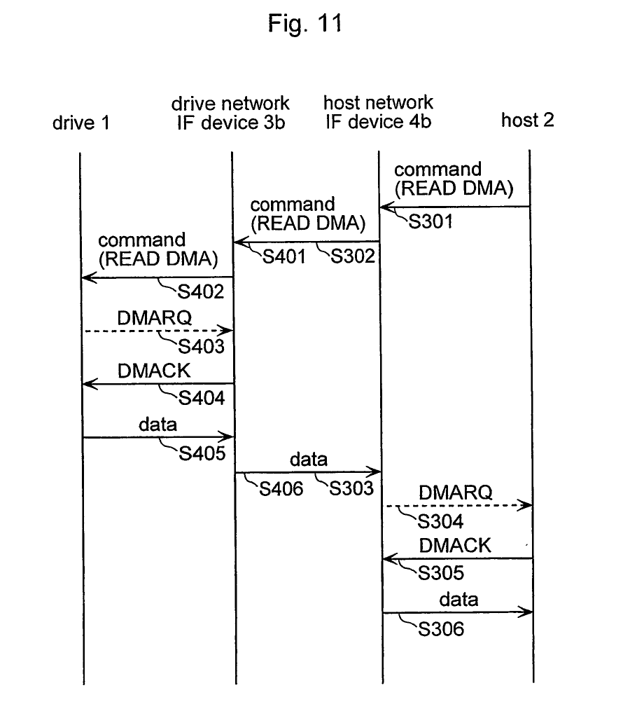

FIG. 9 is a flow that shows an operation of the host network interface device 4B. FIG. 10 is a flow chart that shows an operation of the drive network interface device 3B. FIG. 11 is a sequence diagram that shows a communication flow between each devices when the host 2 reads out data in the drive.

When the host 2 reads out data in the drive, the host 2 sends a READ DMA command. When the IDE interface device 21 in the host network interface device 4B receives the READ DMA command sent from the host 2 (S301), the IDE interface device 21 sends it to the network connecting unit 22. The network connecting unit 22 sends the received READ DMA command to the drive network interface device 3B via the network 5 (S302), and waits for the data which is a response for the READ DMA command to receive from the drive network interface device 3B.

On one hand, when the network connecting unit 12 in the drive network interface device 3B receives the READ DMA command via the network 5 (S401), the network connecting unit 12 sends it to the IDE interface unit 11. The IDE interface unit 11 sends the received READ DMA command to the DVD drive 1 (S402). The DVD drive 1 received this READ DMA command sends a DMARQ signal when data is ready to transfer.

When the IDE interface unit 11 receives the DMARQ signal (S403) from the DVD drive 1 after the READ DMA command is sent, the IDE interface unit 11 sends a DMACK signal which is a response signal for the DMACQ signal to the DVD drive 1 without transferring the DMARQ signal to the network connecting unit 12 (S404). In addition, this DMACK signal is generated by the protocol controlling unit 14 in place of the host 2. When the DVD drive 1 receives this DMACK, the DVD drive 1 carries out a DMA transfer when the data is ready to transfer. And then, when the IDE interface unit 11 receives the data from the DVD drive 1 after the DMACK signal is sent (S405), the IDE interface unit 11 sends the data to the network connecting unit 12 (S406). The network connecting unit 12 sends the received data to the host network interface device 4B via the network 5.

By doing above operation, a communication is established between the drive network interface device 3B and the DVD drive 1 based on the standard. With this communication, only the READ DMA command receiving and the data transmitting operations are carried out via the network 5. There is no sending operation that the DMARQ signal is sent to the network 5 or the DMACK signal is sent via the network 5.

On the other hand, when the network connecting unit 22 in the host network interface device 4B receives the data sent from the drive network interface device 3B, the network connecting unit 22 sends the received data to the IDE interface unit 21. When the IDE interface unit 21 receives the data (S303), a DMARQ signal which indicates the data is ready to transfer is sent to the host 2 (S304). In addition, this DMARQ signal is generated by the protocol controlling unit 24 in place of the DVD drive 1. When the host 2 receives the DMARQ signal, the host 2 sends a DMACK signal which is a response signal for the DMARQ. When the IDE interface unit 21 receives the DMARK signal from the host 2 (S305) after the DMARQ signal is sent, the IDE interface unit 21 sends the data received (S303) from the network connecting unit 22 to the host 2 (S306). As a result, the host 2 is able to read out the data recorded on the disk in the DVD drive 1.

By doing above operation, a communication is established between the host 2 and the host network interface device 4B based on the standard. With this communication, only the READ DMA command receiving and the data transmitting operations are carried out via the network 5. There is no such operation that the DMARQ signal is received via the network 5 or the DMACK signal is sent via the network 5.

Accordingly, this operation will be the time delay for transmitting the DMARQ and the DMACK shortens comparing to the conventional transmission of the DMARQ and the DMACK via the network. Consecutively, the waiting time for the data writing is shortened.

Next, following is an explanation for an operation of the network interface device when the host writes data to the drive.

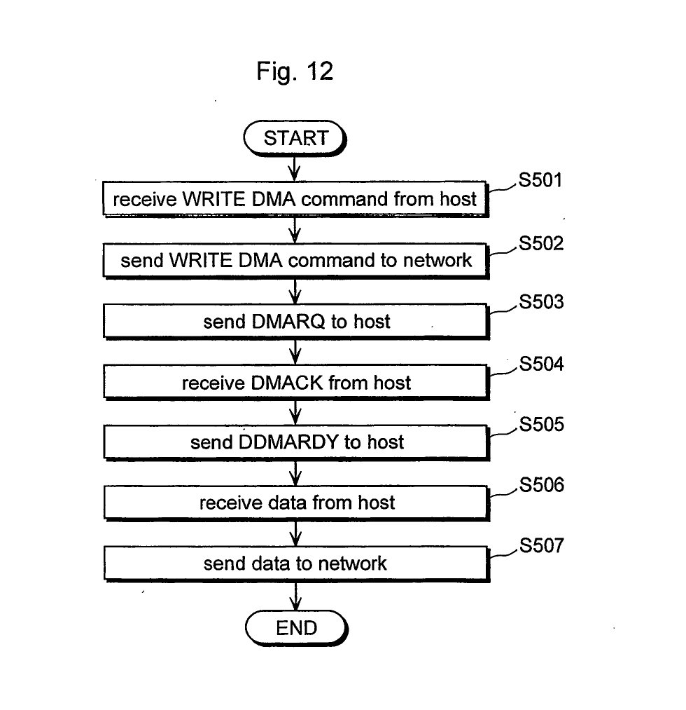

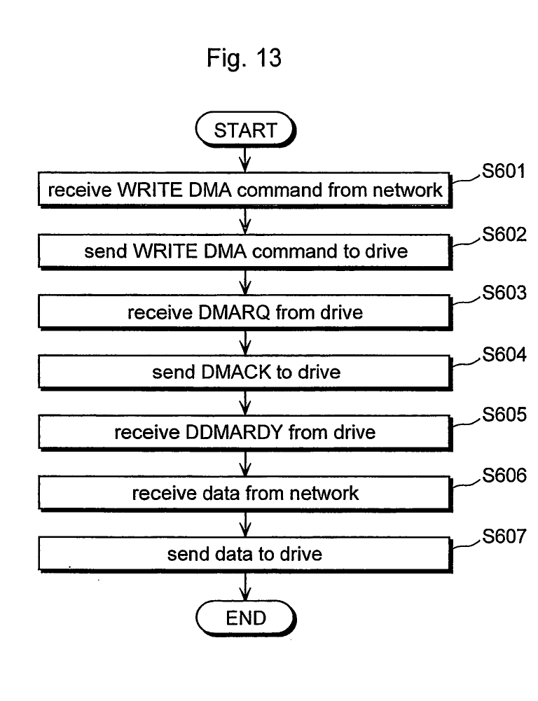

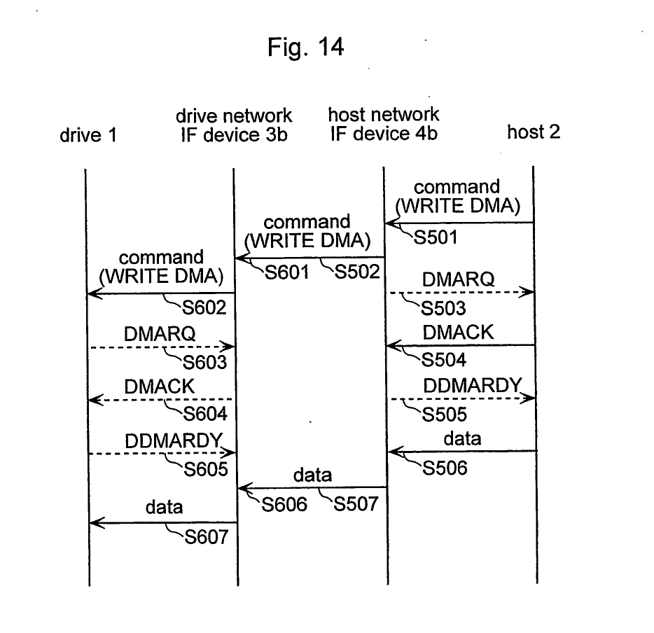

FIG. 12 is a flow chart that shows an operation of the host network interface device 4B. FIG. 13 is a flow chart that shows an operation of the drive network interface device 3B. FIG. 14 is a sequence diagram that shows a communication flow between each devices when the host 2 writes data to the drive.

When the host 2 writes data to the drive, the host 2 sends a WRITE DMA command. When the IDE interface device 21 in the host network interface device 4B receives the WRITE DMA command sent from the host 2 (S501), the IDE interface device 21 sends the command to the network connecting unit 22. The network connecting unit 22 sends the received WRITE DMA command to the drive network interface device 3B via the network 5 (S502).

On one hand, when the network connecting unit 12 in the drive network interface device 3B receives the WRITE DMA command via the network 5 (S601), the network connecting unit 12 sends it to the IDE interface unit 11. The IDE interface unit 11 sends the received WRITE DMA command to the DVD drive 1 (S602). The DVD drive 1 which received this WRITE DMA command sends a DMARQ signal to the drive network interface device 3B when the data is ready to transfer.

When the IDE interface unit 11 in the drive network interface device 3B receives the DMARQ signal (S603) from the DVD drive 1 after the command was sent (S602), the IDE interface unit 11 sends a DMACK signal which is a response signal for the DMACQ signal to the DVD drive 1 (S604). And then, the IDE interface unit waits for receiving a DDMARDY signal, which is sent from the DVD drive 1 when the Ultra DMA data out burst is ready to receive, and the data from the host network interface device 4B. In addition, this DMACK signal is generated by the protocol controlling unit 14 in place of the host 2 as is the same with the reading out processing case.

On the other hand, when the IDE interface device 21 in the host network interface device 4B sends the command (WRITE DMA) to the drive network interface device 3B, the IDE interface device 21 sends the DMARQ signal to the host 2 (S503). This DMARQ signal is generated by the protocol controlling unit 24 in place of the DVD drive 1. The host 2 which received the DMARQ signal sends a DMACK signal to the host network interface device 4B when the data is ready to transfer. When the IDE interface unit 21 receives the DMACK signal from the host 2 (S504), the IDE interface unit 21 sends a DDMARDY signal which is a signal sent when the Ultra DMA data out burst is ready to receive to the host 2 (S505). This DDMARDY signal is generated by the protocol controlling unit 24 in place of the DVD drive 1. When the host 2 receives the DDMARDY signal, the host 2 sends the data to the host network interface device 4B. When the IDE interface unit 21 receives the data from the host 2 (S506), the IDE interface unit 21 sends the data to the network connecting unit 22. The network connecting unit 22 sends the received data to the drive network interface device 3B via the network 5 (S507).

By doing above operation, a communication is established between the host 2 and the host network interface device 4B based on the standard. With this communication, only the sending operation of the WRITE DMA command and receiving operation of the data is carried out via the network 5. There is no such operations that the DMARQ signal or the DDMARDY signal are received via the network 5 or the DMACK signal is sent via the network 5.

The IDE interface device 11 in the drive side receives the DDMARDY signal from the DVD drive 1 (S605). When the IDE interface device 11 in the drive side receives the data outputted from the host network interface device 4B via the network connecting unit 12 (S606), the IDE interface device 11 sends the received data to the DVD drive 1 (S607). As a result, the host 2 is able to write a data to a disk in the DVD drive 1.

By doing above operation, a communication is established between the drive network interface device 3B and the DVD drive 1 based on the standard. With this communication, only the WRITE DMA command receiving and the data transferring operations are carried out via the network 5. There is no sending operation that the DMARQ signal or the DDMARDY signal are sent to the network 5 or the DMACK signal is sent via the network 5.

Accordingly, the time delay for transmitting the DMARQ, the DMACK and the DDMARDY shortens comparing to the conventional transmission of the DMARQ, the DMACK and the DDMARDY via the network. As a result, the waiting time for the data writing is shortened.

As described above, according to the network interface device of the embodiments, when the host reads out data in the drive, or when the host writes data to the drive, the DMA controlling signal (the DMARQ, the DMACK or the DDMARDY) is not transmitted between drives or hosts via networks, thus, there are no influences by the transmission delay in networks. As a result, the processing time of a decoding a DVD data or of the host are increased. Particularly, a stability for an operation is promoted at the time of a real time controlling of the video sound for decoding a DVD video data.

In addition, in the above embodiments, although the IDE interface is used as the external interface for the host and the drive, it is workable using other interfaces such as a SCSI that carries out the DMA transfer.

Also, in the above embodiments, although the DVD decoder is mentioned as an example of the host, a car navigation device may also be applicable. And, although the DVD drive is mentioned as an example of the drive, a hard disk drive or a MO drive may also be applicable. Although the device is implemented as a drive, the other drive such as a GPS may also be implemented.

Also, in the above embodiments, although the optical transmission channel is used as a network 5, the other transmission channel such as a metal or a wireless may also be applicable. And, although the in-vehicle network is used as the network 5, the other networks such as a domestic network, Internet or a network based on the standard besides the MOST such as Ethernet™, a wire network such as a USB or an IEEE1394, the Bluetooth™ or a wireless network such as an IEEE802.11a, 11b may also be applicable. Also, domestic LAN (home LAN) or a remote network are applicable.

Furthermore, although the DVD drive 1 and the drive network interface device 3a and 3b are applied separately, they may well be applied with its combination. Also, the host 2 and the host network interface device 4a and 4b are applied separately, they may well be applied with its combination, that is, the drive device and the host device corresponding to network can be realized.

Furthermore, in the above second or third embodiments, the drive network interface device 3b and the protocol controlling unit 14 are separately composed, however, the IDE interface unit 11 can substitute the function of the protocol controlling unit 14. That is, when the network connecting unit 12 receives a command packet, the IDE interface unit 11 executes a series of signal sending and receiving processing until the period of sending the command packet, then sends the command packet to the DVD drive 1.

Also, in the above second or third embodiments, the host network interface device 4b and the protocol controlling unit 24 are applied separately, however, the IDE interface unit 21 can substitute the function of the protocol controlling unit 24. That is, when the IDE interface unit 21 receives information for the partner's device except information of the request for status reading out from the host, the IDE interface unit 21 executes a series of information sending and receiving processing for sending only the entity information that the partner's device needs, to the network via the network connecting unit 22. The following processing is also applicable. After the IDE interface unit 21 executes a series of signal sending and receiving processing during a period from receiving a packet command from the host and to receiving a command packet including the processing of sending the status, only the command packet received from the host can be sent to the network via the network connecting unit 22. In this case, the component of the host network interface device 4b can be simplified. And, using the shadow register 23 substituting for the status register 25, the status which is stored/updated periodically may well be used.

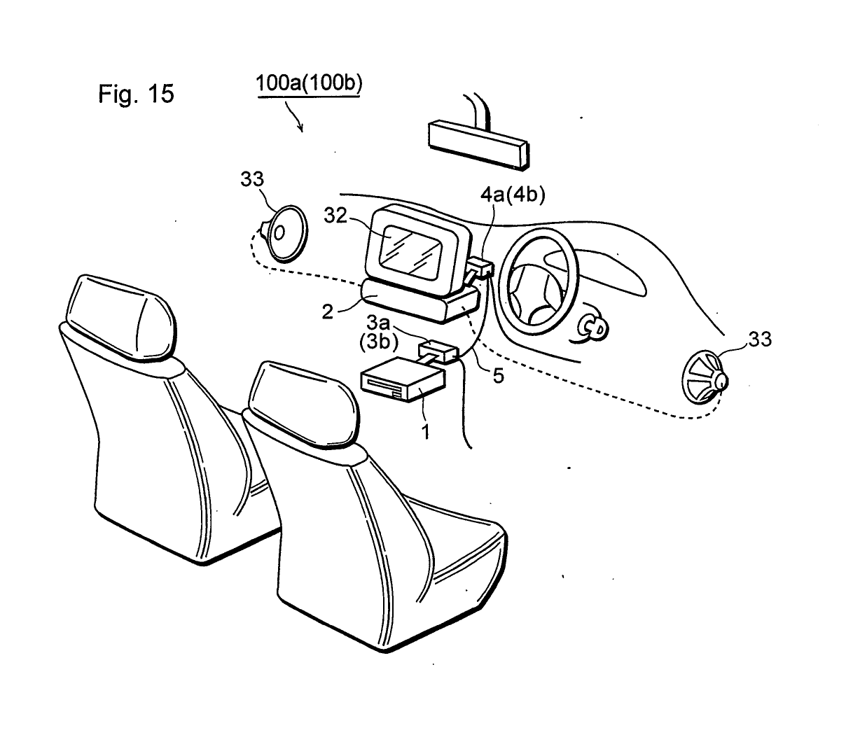

FIG. 15 is a diagram that shows a car inside applied the disk system 100a (100b) to the car navigation system of the above first embodiment to the third embodiment.

As shown, the system 100a and 100b are having a network 5 installed in the car, a drive network interface device 3a (3b) and a host network interface device 4a (4b). Those are each connected to the network 5, the network interface device 3a (4a) connected each to a DVD drive 1 and the host network interface device 4a (4b). By doing these connections, the DVD drive 1 and the DVD decoder 2 would be in a status that as if two are connected directly, however the network 5 is involved.

By inserting a disk for the car navigation to the DVD drive 1 and operating a play button (not shown) on the DVD decoder 2, a map information, that is corresponding to the car location, is transmitted to the DVD decoder2 via the DVD drive 1, the drive network interface device 3a (3b), the network 5, and the host network interface device 4a (4b) without delay. After the decoding processing is executed in the DVD decoder 2, a map, around in this vicinity, is shown onto the display 32 with a guidance play-backed from a speaker 33. With operating a record button (not shown) of the DVD decoder 2, it is needless to say that the transmission delay is few in number when the case of sending data from the DVD decoder 2 to the DVD drive 1.

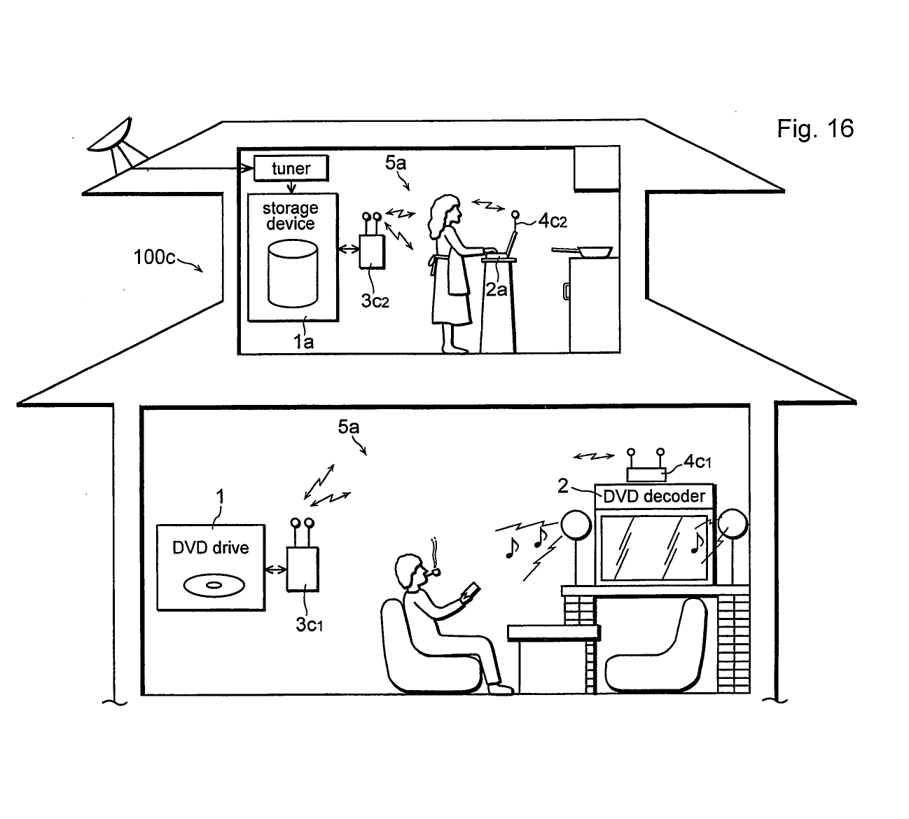

FIG. 16 is a diagram that shows a home inside applied the disk system to the home network of above first to third embodiments.

In this home network system, a wireless network 5a (i.e. IEEE802.11a) is adopted in place of the above wire network 5. And this system establishes a communication between a plurality of drives (i.e. the DVD drive 1 and the storage device 1a) and a plurality of hosts (i.e. the DVD decoder 2 and the personal computer 2a) via the wireless network 5a. That is, a drive network interface device 3c1 and 3c2, which are corresponding to a wireless communication, are placed between the wireless network 5a, the DVD decoder 2 and the personal computer 2a, and each are connected. And, a host network interface device 4c1 and 4c2, which are corresponding to a wireless communication, are placed between the wireless network 5a, the DVD decoder 2 and the personal computer 2a, and each are connected. In addition, a storage device 1a is comprised of a satellite broadcasting received from a tuner and a large-capacity hard disk drive that stores a plurality of contents of a terrestrial broadcasting.

According to the above-mentioned disk system 100c, the processing, explained above first to third embodiments, is executed by adding the drive network interface device 3c1 and 3c2 and the host network interface device 4c1 and 4c2.

Accordingly, the wireless network 5a is involved however, the DVD drive 1, the storage device 1a, the DVD decoder 2 and the personal computer 2a would be in a status that as if above four devices are connected directly each other, so it is possible to view the desired contents such as movies by calling up from the DVD drive 1 and the storage device 1a via the DVD decoder 2 in the living room without delay. Also, it is possible to view the desired contents such as a cooking program with the personal computer 2a without delay. Also, it is needless to say that there are only a few transmission delays for sending data from the DVD decoder 2 and the personal computer 2a to the DVD drive 1 and the storage device 1a.

Industrial Applicability

The interface device according to the present invention is applicable for establishing a communication as a communication device between a host with a direct connection basis (i.e. a PC, a decoder) and a drive (i.e. a DVD drive, HD drive) that is able to do any one of reading and writing.

1-4. (Cancelled).

5. A drive network interface device that is connected between a drive that is able to do at least any one of reading and writing, and a network, comprising:
a network connecting unit operable to establish a communication with the network; and
a substitution unit, which is connected to the drive for communication, operable to execute a series of information sending and receiving processing with a disk as a substitute for a partner's device and send only the entity information to the partner's device via the network connecting unit and the network upon receiving information from the partner's device.

6. The drive network interface device according to claim 5, wherein the substitution unit includes:
a drive interface that establishes a communication with the drive; and
a protocol controlling unit, that is connected to the drive interface and the network connecting unit, operable to execute a series of signal sending and receiving processing when the network connecting unit receives the command packet, and then sends the command packet to the drive.

7. The drive network interface device according to claim 5,
wherein the substitution unit is a drive interface that sends a DMA reading out command to the drive when the network connecting unit receives the DMA reading out command, then executes a series of signal sending and receiving processing until a period of starting a DMA transfer with the drive, and sends the data received from the drive via the network.

8. The drive network interface device according to claim 5,
wherein the substitution unit is a drive interface that sends a DMA writing command to the drive when the network connecting unit receives the DMA writing command, then executes a series of signal sending and receiving processing until a period of starting data transfer with the drive, and sends the data that the network connecting unit received to the drive.

9. The drive network interface device according to claim 5,
wherein the drive interface conforms to the ATA/ATAPI-standards.

10. A network-connectable drive device includes a drive, which is able to do at least any one of reading and writing, to which a drive network interface device according to claim 5 is connected.

11-15. (Cancelled).

16. A host network interface device that is connected between a host and a network, comprising:
a network connecting unit operable to establish a communication with the network; and
a substitution unit, which is connected to the host for communication, operable to execute a series of information sending and receiving processing with the host as a substitute for a partner's device, upon receiving the information for the partner's device from the host, and send only the entity information to the partner's device via the network connecting unit and the network.

17. The host network interface device according to claim 16,
wherein the substitution unit includes:
a host interface that establishes a communication with the host; and
a protocol controlling unit, that is connected to the host interface and the network connecting unit, operable to send only a command packet received from the host via the network connecting unit and the network, when the host interface executed a series of signal sending and receiving processing during a period from receiving a packet command to receiving a command packet.

18. The host network interface device according to claim 17 further comprising a status register that memorizes a status of the host interface,
wherein the protocol controlling unit sends the status memorized in the status register to the host, when the host interface receives a signal for requesting the status sent from the host.

19. The host network interface device according to claim 16,
wherein the host interface executes a series of information sending and receiving processing with the host after sending a DMA reading out command via the network connecting unit and the network, upon receiving the command from the host, and then sends a data received from the network to the host.

20. The host network interface device according to claim 16,
wherein the host interface executes a series of information sending and receiving processing with the host after sending a DMA writing command via the network connecting unit and the network, upon receiving the command from the host, and then sends a data received from the network to the host.

21. The host network interface device according to claim 16,
wherein the host interface conforms to the ATA/ATAPI-standards.

22. A network-connectable host device includes a host device to which a host network interface device according to claim 16 is connected.

23 (Cancelled)

24. A communication system that sends and receives an information between a host and a drive that is able to do at least any one of reading and writing, with a direct connection basis via a network, comprising:
a first interface device that is connected between the host and the network;
a second interface device that is connected between the drive and the network; and
an information distinction unit, that is connected to any one of the first interface device and the second interface device, operable to distinguish an entity information for being transferred between the host and the drive from a communication proceeding information for transferring the entity information among the information,
wherein the first interface device includes:
a first substitution sending and receiving unit operable to send and receive the communication proceeding information to and from the host substituting for the drive; and
a first entity information sending and receiving unit operable to send and receive the entity information to and from the second interface device, and
the second interface device includes:
a second entity information sending and receiving unit operable to send and receive the entity information to and from the first interface device; and
a substitution sending and receiving unit operable to send and receive the communication proceeding information to and from the drive as a substitute for the host.

25. An information transmitting method for transmitting a certain content of a communication data from a first device to a second device via a communication network, including:
a step for receiving the communication data while communicating a control data for controlling a transmission with the first device, in a first interface device connected between the first device and the communication network;
a step for sending only the communication data received from the first device to a second interface device connected between the second device and the communication network via the communication network, in the first interface device; and
a step for sending the communication data received from the first interface device to the second device while communicating the control data with the second device for controlling a transmission, in the second interface device.

26. The information transmitting method according to claim 25,
wherein the communication data is a command packet that includes an operation instruction from the first device to the second device, and
the control data includes a status reading out instruction for confirming whether a device for receiving the command packet is ready to receive the command packet or not, and a response to the instruction.

27. The information transmitting method according to claim 25,
wherein the communication data is the data memorized in the first device, and
the control data includes an instruction for requesting the communication and a response to the instruction.
